(19) United States
(12) Patent Application Publication
(10) Pub. No.: US 2003/0146813 A1
(43) Pub. Date: Aug. 7, 2003

(54) Magnet housing

(76) Inventors: Thomas Holly, Philadelphia, PA (US); William Angstadt, Marlton, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/359,350

(22) Filed: Feb. 5, 2003

Related U.S. Application Data
(60) Provisional application No. 60/355,738, filed on Feb. 5, 2002.

(51) Int. Cl. H01F 5/00

(52) U.S. Cl. 335/299

(57) ABSTRACT

A magnet housing including a first semicircular portion and a second semicircular portion coupled to the first semicircular portion, such that the first and second semicircular portions each include at least one magnet structure disposed therein.

### RELATED APPLICATIONS

The present application claims priority under 35 U.S.C. §120 of U.S. Provisional Patent Application No. 60/355,738, filed Feb. 5, 2002.

### FIELD OF THE INVENTION

This present invention relates to housings for retaining magnets and magnet structures.

### BACKGROUND OF THE INVENTION

The nuclear power industry spends a significant amount of effort to protect their employees and the environment from exposure to nuclear radiation. One area where radiation conditions arise is within the water circulation systems within the plant. Even though the nuclear power industry takes care to make the water as contamination free as possible, some impurities are carried along with the water. A situation occurs whereupon materials, such as the residuals of the aforementioned impurities, build up inside the pipes and equipment. These build ups have elevated levels of radiation and cause the built up areas to exhibit high “dose rates” of radiation, commonly known as “hot spots.”

As will be understood, these hot spots must be identified, monitored and shielded or eliminated in order to protect the facility and the personnel. To date there have been many attempts to eliminate these hot spots, however, most of these attempts are either extremely costly, or have failed.

Conventional methods for removing hot spots include flushing the system with excessive amounts of water in order to dislodge the buildups. However, this method is not always effective, as buildups inside the pipes can be difficult to remove with water pressure alone. Another method involves physically cutting away the affected pipe section and replacing it with a new pipe section. Yet another method envisions adding chemicals to the water to dissolve the built up material. However, the integrity of the fluid in the pipes is very important to the operation of the system, and engineers are typically reluctant to add chemicals to the fluid system.

Therefore, there is presently a need for a system for removing impurities from fluids flowing in pipe systems which does not suffer from the above-mentioned problems.

### SUMMARY OF THE INVENTION

The present invention comprises a magnet housing including a first semicircular portion and a second semicircular portion coupled to the first semicircular portion, such that the first and second semicircular portions each include at least one magnet structure disposed therein.

The present invention also comprises a method for removing impurities from fluids flowing in a pipe utilizing a magnet structure including the steps of disposing a first semicircular portion of the magnet structure on a first side of a pipe, disposing a second semicircular portion of the magnet structure, coupled to the first semicircular portion, on a second side of said pipe, and securing the first and second semicircular portions around the pipe.

### BRIEF DESCRIPTION OF THE DRAWINGS

FIG. 1 shows an isometric view of the magnet housing according to an exemplary embodiment of the present invention in a closed position.

FIG. 2 shows the magnet housing of FIG. 1 in an open position.

FIG. 3 shows the magnet housing of FIG. 1 in a closed position with a pipe inserted therein.

FIG. 4 shows a cross sectional view of the magnet housing of FIG. 3, taken across lines 4-4.

### DETAILED DESCRIPTION

The present invention comprises a magnet housing for retaining a plurality of magnets around the circumference of a tubular member (e.g., pipe). The invention uses the principles of magneto hydrodynamics to change the physical properties of fluids flowing in a pipe, such that material which may become built up around the inner periphery of the pipe will be dislodged from the pipe and become suspended in the fluid. The suspended particles are then flushed out from the pipe. The present invention reduces the occurrence of “hot spots” in nuclear power system pipes by prohibiting particles in the fluid from building up and creating areas of high radiation.

The present invention is particularly effective because it may be installed around the outer periphery of the affected pipes, and does not significantly interfere with the normal operation of the pipe system. The size and weight of the present invention is small relative to the pipe system, and thus does not require additional supports for installation.

The present invention reduces the effect of hot spots in a pipe system such that personnel can safely operate adjacent to the position of the hot spot. This allows the nuclear power facility to reduce costs and ensure the safe operation of the nuclear power facility.

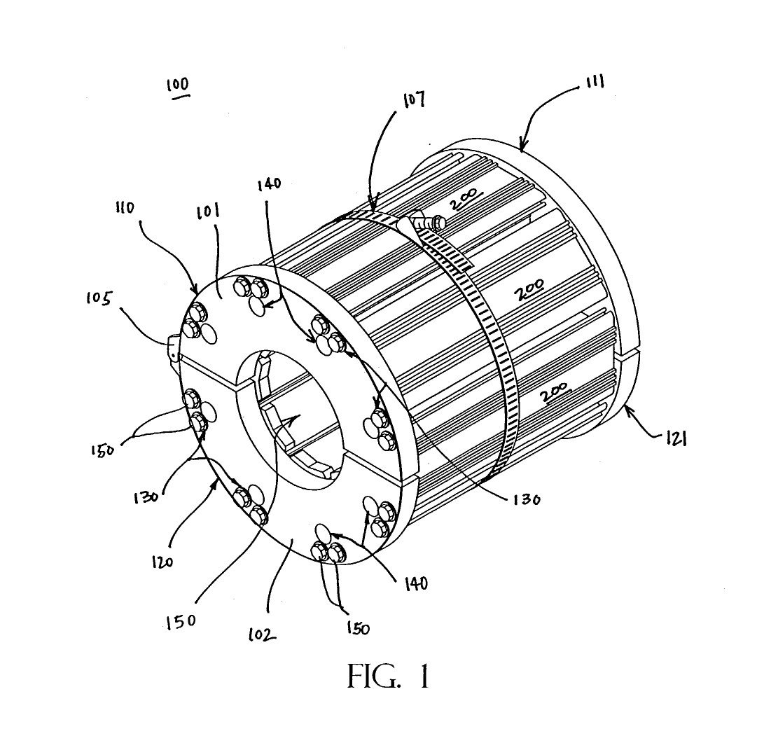

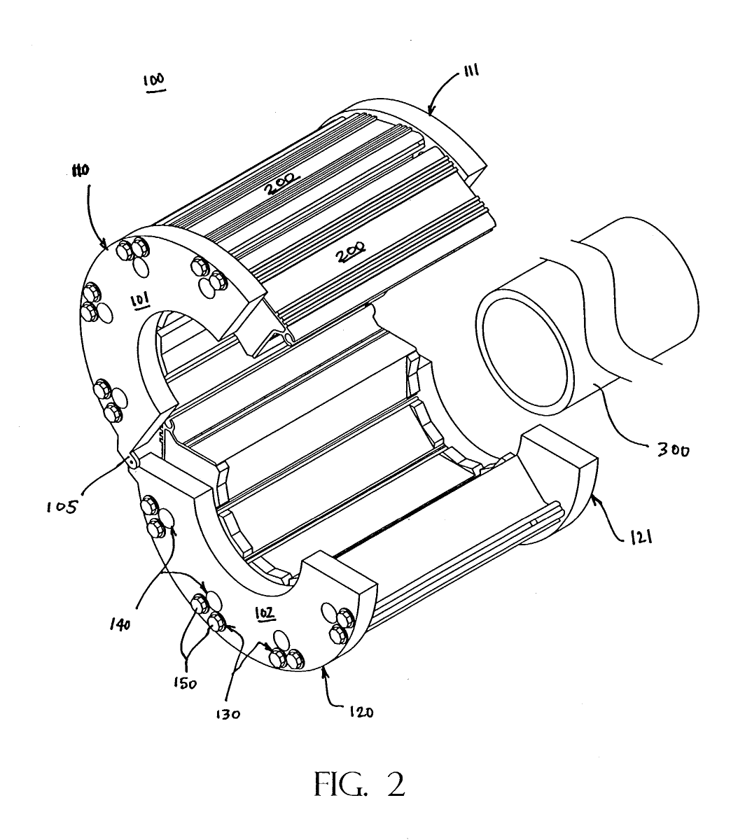

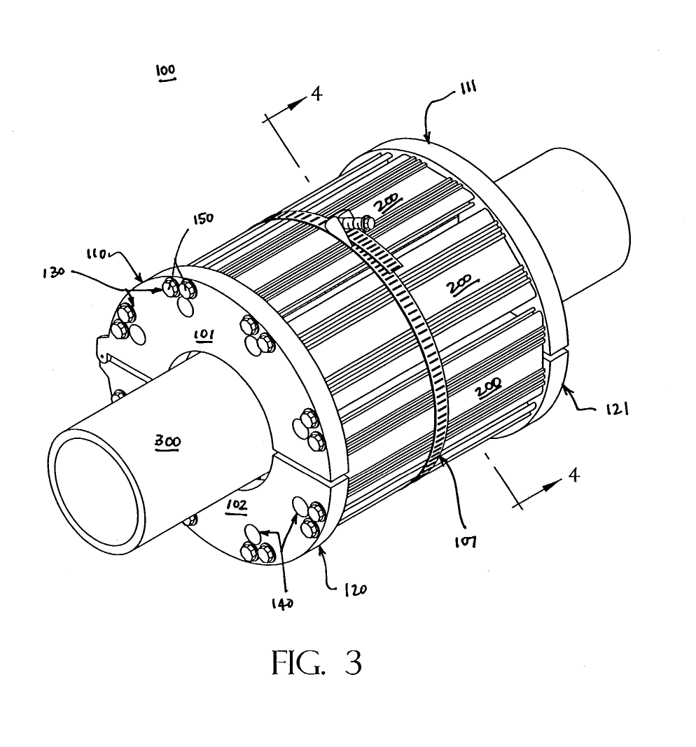

FIG. 1 shows a magnet housing 100 which includes a first semicircular portion 101 and a second semicircular portion 102 disposed opposite the first semicircular portion. The first and second semicircular portions 101, 102 are coupled to one another through a hinge 105. The hinge 105 permits the first and second semicircular portions 101, 102 to move with respect to one another from a ‘closed’ position (e.g., where the first and second semicircular portions contact one another; See FIGS. 1 and 3) to an ‘open’ position (e.g., where the first and second semicircular portions are separated from one another; See FIG. 2), and positions therebetween.

The first semicircular portion 101 includes a first semicircular end plate 110 and a second semicircular end plate 111. Similarly, the second semicircular portion 102 includes a first semicircular end plate 120 and a second semicircular end plate 121. The first and second semicircular portions 101, 102 together form a substantially circular opening 150 for receiving a pipe 300 therein (See FIG. 2).

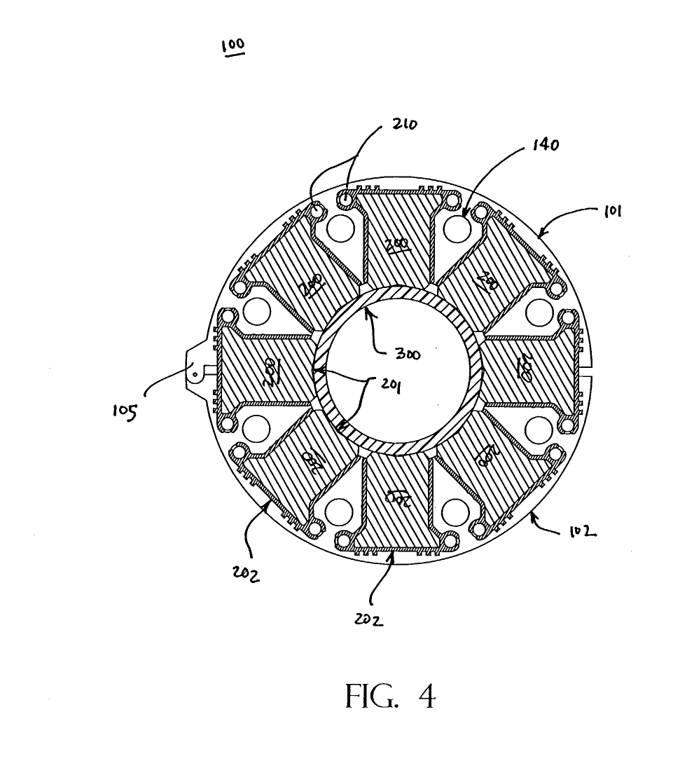

The magnet housing 100 also includes a plurality of magnets 200 which are coupled to the first and second semicircular portions 101, 102. As shown in FIG. 4, each of the magnets 200 is substantially T-shaped with the base of the “T” being disposed adjacent the opening 150. Each of the magnets 200 includes therein substantially circular passageways 210 for receiving bolts 150 for securing the magnets within the magnet housing 100 as explained below. The magnet housing 100 may also include an optional fastener 107 which extends around the periphery of the magnet housing for providing an additional means of securing the magnets 200 within the housing.

Each of the end plates 110, 111, 120 and 121 includes therein a plurality of small openings 130 and a plurality of large openings 140. As shown in FIG. 1, each of the plurality of small openings 130 includes bolts 150 therein which extend from each of the first end plates 10, 120 to each of the second end plates 111, 121. As will be understood by those skilled in the art, the bolts 150 may be secured at the respective second end plates 111, 121 by nuts or other equivalent fasteners (not shown).

As mentioned above, each of the magnets 200 also includes passageways 210 for receiving the bolts 150 (See FIG. 4). Thus, once the, bolts 150 are passed through the first 110, 120 and second 111, 121 end plates of each semicircular portion 101, 102, and through the passageways 210 of each magnet 200, the magnets become fixed at a distinct position within the magnet housing 100. Although small openings 130 are used to secure the magnets 200 in the exemplary embodiment shown in FIG. 1, large openings 140 may also be used to secure magnets within the magnet housing 100. Alternatively, the first and second semicircular portions 101, 102 may be provided with different sets of openings (i.e., other than the large and small openings discussed above) for securing the magnets.

FIG. 2 shows the magnet housing 100 in an ‘open’ position such that the magnet housing may receive a pipe 300. The pipe 300 may carry a liquid (e.g., water) therein. The magnet housing 100 provides for purification of the liquid within the pipe because the magnets 200 serve to suspended particles and impurities within the liquid so as to prohibit the particles and impurities from passing to the destination of the liquid (e.g., spigot).

FIG. 3 shows the magnet housing 100 in a ‘closed’ position with a pipe 300 inserted therein. As shown in FIG. 3, the magnet housing 100 completely surrounds the pipe 300.

FIG. 4 shows a cross sectional view of the magnet housing 100 of FIG. 3, taken along lines 4-4. As shown in FIG. 4, a first end 201 of each of the magnets 200 is disposed against and outer periphery of the pipe 300. A second end 202 of each magnet includes passageways 210 therein for receiving bolts 150 as discussed above.

The magnet housing 100 according to the exemplary embodiment of the present invention provides a simple and efficient device for securing magnets around a pipe to permit purification of liquid within the pipe. As noted above, the magnets 200 within the magnet housing 100 are used to assist in the removal of particles and impurities from liquid within the pipe 300.

Although the present invention is described above as for use in pipe systems for the nuclear power industry, those of ordinary skill in the art will note that the present invention has application in any industry where the build up of deposits within pipes requires reduction or elimination.

What is claimed is:

1. A magnet housing comprising:
a first semicircular portion; and
a second semicircular portion coupled to the first semicircular portion,
wherein the first and second semicircular portions each include at least one magnet structure disposed therein.

2. The magnet housing of claim 1, wherein each at least one magnet structure comprises a substantially T-shaped magnet structure.

3. The magnet housing of claim 1, wherein each at least one magnet structure comprises at least one passageway therein extending the length of the magnet structure.

4. The magnet housing of claim 1, wherein the first and second semicircular portions each include at least one opening therein.

5. The magnet housing of claim 3, wherein the first and second semicircular portions each include at least one opening therein corresponding to the at least one passageways in the at least one magnet structures.

6. The magnet housing of claim 1, wherein the first and second semicircular portions are each comprised of first and second semicircular end plates.

7. The magnet housing of claim 6, wherein each of the at least one magnet structures are disposed between the first and second semicircular end plates of each of the first and second semicircular portions.

8. The magnet housing of claim 1, further comprising:
at least one fastening means for securing each at least one magnet structure to the respective first and second semicircular portions.

9. The magnet housing of claim 8, wherein each at least one fastening means extends entirely through each at least one magnet structure.

10. The magnet housing of claim 8, wherein the fastening means comprises a bolt extending through each at least one magnet structure.

11. A method for removing impurities from fluids flowing in a pipe utilizing a magnet structure comprising the steps of:
disposing a first semicircular portion of the magnet structure on a first side of a pipe;
disposing a second semicircular portion of the magnet structure, coupled to the first semicircular portion, on a second side of said pipe; and
securing the first and second semicircular portions around the pipe.

12. The method of claim 11, wherein the first and second semicircular portions each include at least one magnet structure disposed therein.

13. The method of claim 12, wherein each at least one magnet structure comprises at least one passageway therein extending the length of the magnet structure.
